(19) United States
(12) Patent Application Publication
(10) Pub. No.: US 2026/0048992 A1
(43) Pub. Date: Feb. 19, 2026

(54) PRECIPITATED SILICA

(71) Applicant: TATA CHEMICALS LIMITED, Mumbai (IN)

(72) Inventors: Debabrata RAUTARAY, Mulshi, Pune (IN); Prabhat PARIDA, Mulshi, Pune (IN); Sunil ROKADE, Mulshi, Pune (IN); Amit GUPTA, Mulshi, Pune (IN)

(21) Appl. No.: 19/104,500

(22) PCT Filed: Aug. 16, 2023
(86) PCT No.: PCT/IB2023/058232

§ 371 Date: Feb. 18, 2025

(30) Foreign Application Priority Data
Aug. 17, 2022 (IN) 202221046692

(51) Int. Cl. C01B 33/187

(52) U.S. Cl. CPC C01B 33/187; C01P 2004/61; C01P 2006/12; C01P 2006/14

(57) ABSTRACT

A precipitated silica is disclosed. Said precipitated silica has a BET surface area of 165-195 m²/g; a CTAB surface area of 160-180 m²/g; a vicinal silanol content of 14 to 21%; a geminal silanol content of 2 to 4%; a total intrusion volume of 2 to 4 mL/g; a pore volume ratio (V2/V1) of 0.45 to 0.7; and a total pore area ranging from 52 to 70 m²/g.

### FIELD OF INVENTION

The present disclosure relates to precipitated silica which exhibits high dispersibility in an elastomer composition.

### BACKGROUND

Silica is well-known for use as a reinforcing filler in vulcanizable rubber mixtures, such as those used to form tyres. The reinforcing fillers used in tyre compounding are critical for achieving the performance requirements and substantially assist in strengthening the rubber network thereof, resulting in a substantial increase in stiffness, tensile strength, and abrasion resistance. This in effect contributes towards increasing the longevity of tyres while reducing fuel consumption. However, not all types of silica could be used to reinforce elastomers. The silica used in the tyre industry is generally precipitated silica, characterized by its particle size, structure, and surface activity.

It is known that the properties of precipitated silica affect the reinforcement properties thereof. This necessitates identifying the characteristic attributes of silica suited for requirement profiles of different applications.

Depending on the characteristic attributes, various grades of precipitated silica are known. However, there is still a need to develop precipitated silica having a desirable blend of properties while exhibiting good dispersion and reinforcement when added to an elastomer composition.

### SUMMARY

A precipitated silica is disclosed. Said precipitated silica has a BET surface area of 165-195 m²/g; a CTAB surface area of 160-180 m²/g; a vicinal silanol content of 14 to 21%; a geminal silanol content of 2 to 4%; a total intrusion volume of 2 to 4 mL/g; a pore volume ratio (V2/V1) of 0.45 to 0.7; and a total pore area ranging from 52 to 70 m²/g.

### DETAILED DESCRIPTION

For the purpose of promoting an understanding of the principles of the disclosure, reference will now be made to embodiments and specific language will be used to describe the same. It will nevertheless be understood that no limitation of the scope of the disclosure is thereby intended, such alterations and further modifications in the disclosed composition and method, and such further applications of the principles of the disclosure therein being contemplated as would normally occur to one skilled in the art to which the disclosure relates.

It will be understood by those skilled in the art that the foregoing general description and the following detailed description are exemplary and explanatory of the disclosure and are not intended to be restrictive thereof.

Reference throughout this specification to “one embodiment” “an embodiment” or similar language means that a particular feature, structure, or characteristic described in connection with the embodiment is included in at least one embodiment of the present disclosure. Thus, appearances of the phrase “in one embodiment”, “in an embodiment” and similar language throughout this specification may, but do not necessarily, all refer to the same embodiment.

The terms “comprise”, “comprising”, or any other variations thereof, are intended to cover a non-exclusive inclusion and are not intended to be construed as “consists of only”, such that a process or method that comprises a list of steps does not include only those steps but may include other steps not expressly listed or inherent to such process or method.

Likewise, the terms “having” and “including”, and their grammatical variants are intended to be non-limiting, such that recitations of said items in a list are not to the exclusion of other items that can be substituted or added to the listed items.

Although any methods and materials similar or equivalent to those described herein can be used in the practice or testing of the disclosure, the preferred methods, and materials are now described. All publications mentioned herein are incorporated herein by reference.

Unless defined otherwise, all technical and scientific terms used herein have the same meaning as commonly understood by one of ordinary skill in the art to which this disclosure belongs. It will be further understood by those skilled in the art that the various physico-chemical parameters stated herein have the same meaning as generally understood in the art, unless specifically stated otherwise.

The term “BET surface area”, named after Brunauer, Emmett and Teller, refers to the total surface area of silica which is determined by the adsorption of nitrogen on the surface of silica. BET surface area is determined according to ISO 5794-1/Annex D.

The term “CTAB surface area” refers to external surface area of silica which is determined by the adsorption of Cetyl trimethyl ammonium bromide (CTAB) on the surface of silica. CTAB surface area is determined according to ASTM 3765, or NFT 45-007.

The ratio of said two parameters viz. BET/CTAB provides a measure of microporosity.

The term “DOA absorption value” measures the amount of di-(2-ethylhexyl) adipate (DOA) absorbed by silica. The DOA absorption value provides an indication of the void volume formed by the aggregates and agglomerates of silica. DOA absorption value is determined according to ASTM D6854.

The term “sears number” provides a measurement of concentration of silanol groups on the precipitated silica and provides an indication of surface activity of silica. The silanol groups on the surface of precipitated silica function as potential chemical reaction sites for a coupling reagent, which permit coupling of the silica to the elastomer matrix.

The term “ratio of sears Number/CTAB surface area” provides the concentration of silanol groups for a given level of CTAB surface area.

The term “ratio of sears Number/BET surface area” provides the concentration of silanol groups for a given level of BET surface area.

The term “vicinal silanol” refers to hydrogen bonded silanol groups and the term “geminal silanol” refers to silanol having two OH groups linked to the same surface silicon atom to give the Si(OH)₂ moiety. The term “siloxane group” refers to siloxane groups or ≡Si—O—Si≡ bridges with oxygen atoms on the silica surface. Solid state Si NMR was conducted to measure the vicinal silanol, geminal silanol and siloxane group content.

The term “pore volume ratio (V2/V1)” refers to the ratio of pore volume V2 and pore volume V1, where pore volume V1 is determined from the cumulated pore volume in the pore diameter range of 5.5-40 nm, and pore volume V2 is determined from the cumulated pore volume in the pore diameter range of 17.5-27.5 nm. Pore volume ratio (V2/V1) provides the effective pore volume of the filler material for reinforcing elastomer/rubber matrices.

In its broadest scope, the present disclosure relates to a precipitated silica having high dispersibility in the matrix of an elastomer composition. Particularly, the present disclosure relates to a precipitated silica having:
a BET surface area of 165-195 m²/g;
a CTAB surface area of 160-180 m²/g;
a vicinal silanol content of 14 to 21%;
a geminal silanol content of 2 to 4%;
a total intrusion volume of 2 to 4 mL/g;
a pore volume ratio (V2/V1) of 0.45 to 0.7; and
a total pore area ranging from 52 to 70 m²/g.

The present inventors found that aforesaid combination of physico-chemical parameters brings about an improvement in dispersibility of precipitated silica in the elastomer matrix. Specifically, said combination of physico-chemical parameters leads to a precipitated silica exhibiting effective silanization during mixing with elastomer composition resulting in better cross-linking density of silica, lower filler-filler interaction and better macro and micro dispersion of silica in elastomer matrix, resulting in better reinforcement when used in elastomer compositions.

In an embodiment, the precipitated silica has the BET surface area in the range of 170-190 m²/g. In some embodiments, the precipitated silica has the BET surface area of 180 m²/g.

In an embodiment, the precipitated silica has the CTAB surface area in a range of 165-175 m²/g. In some embodiments, the precipitated silica has the CTAB surface area of 170 m²/g.

In an embodiment, the BET/CTAB of the precipitated silica is in the range of 1-1.15.

In an embodiment, the precipitated silica has the vicinal silanol content of 14.86 to 20.86%. In some embodiments, the precipitated silica has the vicinal silanol content of 17.86%.

In an embodiment, the precipitated silica has the geminal silanol content of 2 to 3.44%. In some embodiments, the precipitated silica has the geminal silanol content of 2.44%.

In an embodiment, the precipitated silica has the total intrusion volume of 2 to 3.51 mL/g. In some embodiments, the precipitated silica has the total intrusion volume of 2.51 mL/g.

In an embodiment, the precipitated silica has the pore volume ratio (V2/V1) of 0.48 to 0.68. In some embodiments, the precipitated silica has the pore volume ratio (V2/V1) of 0.58.

In an embodiment, the precipitated silica has a total pore area ranging from 55-65 m²/g. In some embodiments, the precipitated silica has the total pore area of 60 m²/g.

In an embodiment, the precipitated silica has a DOA absorption value in the range of 240-310 ml/100 g. In some embodiments, the precipitated silica has the DOA absorption value of 242-302 ml/100 g.

In an embodiment, the precipitated silica has a siloxane group content of 74 to 85%. In some embodiments, the precipitated silica has the siloxane group content of 79.69%.

In an embodiment, the precipitated silica has a total pore volume of 1.50 to 3.6 ml/g. In some embodiments, the precipitated silica has the total pore volume of 2.51 ml/g.

In an embodiment, the precipitated silica has a particle size distribution D₅₀ ranging from 14 to 21 μm. In some embodiments, the precipitated silica has the particle size distribution D₅₀ of 17.9 μm.

In an embodiment, the precipitated silica has sears number (V₂) in a range of 19 to 25 ml/(5 g). In some embodiments, the precipitated silica has the sears number (V₂) of 22 ml/(5 g). In an embodiment, the precipitated silica has a silanol density w.r.t. total surface area of silica, measured by a ratio of sears number and BET surface area in a range of 0.11 to 0.13 mL/5 m². In some embodiments, the ratio of sears number and BET surface area is 0.12 mL/5 m². In an embodiment, the precipitated silica has a silanol density w.r.t. external surface area of silica, measured by a ratio of sears number (V₂) and CTAB surface area is in a range of 0.11 to 0.15 mL/5 m². In some embodiments, the precipitated silica has the ratio of sears number (V₂) and CTAB surface area of 0.13 mL/5 m².

In an embodiment, the precipitated silica according to the present disclosure has a ratio of silanol group density and BET surface area in a range of 12.24 to 16.24 Number OH/nm².

In an embodiment, the precipitated silica a particle size distribution D₅₀ ranging from 14 to 21 μm. In some embodiments, the precipitated silica has the particle size distribution D₅₀ in the range of 14.9 to 20.9 μm. In some embodiments, the precipitated silica has the average primary particle size of 17.9 μm.

In an embodiment, the precipitated silica has an average particulate aggregate size ranging from 100-500 nm. In some embodiments, the precipitated silica has the average particulate aggregate size ranging from 200-400 nm.

In an embodiment, the precipitated silica has a pH value of 6-6.5 (5% in water).

A process for preparing the disclosed precipitated silica is also described herein. Said process comprises the steps of:
a) reacting an aqueous solution of a metal silicate with a mineral acid in the presence of a surfactant solution comprising C8-C20 sulfosuccinate blend, at a reaction temperature in a range of about 75 to 90° C. with constant stirring such that a reaction mixture having a pH of about 8 to 10 is obtained;
b) feeding the aqueous solution of the metal silicate, the mineral acid and the surfactant solution to the reaction mixture and allowing the resultant reaction mixture to age at a temperature in a range of about 75 to 90° C. for a time period in a range of 10 minutes to 30 minutes, and adjusting the pH of the reaction mixture to about 8 to 10;
c) feeding the aqueous solution of the metal silicate, the mineral acid and the surfactant solution to the reaction mixture followed by aging said mixture at a temperature in a range of about 75 to 90° C. for a time period in a range of 5 minutes to 10 minutes, and adjusting the pH of the reaction mixture to about 3.5 to 4; and
d) recovering the precipitated silica from the reaction mixture.

The present inventors found the aforesaid surfactant along with reaction parameters such as concentration of reactants, pH, temperature, ageing time and number of reaction phases, act in a synergistic manner to control the physico-chemical parameters of disclosed precipitated silica.

In an embodiment, the surfactant solution is prepared by addition of C8-C20 sulfosuccinate blend to water at an ambient temperature. In an embodiment, the surfactant solution comprises C8-C20 sulfosuccinate blend in an amount ranging from 10-30 gpl. In an exemplary embodiment, commercially available C8-C20 sulfosuccinate blend, such as Surfactant-OT 85 AE (from CYTEC) was used.

In an embodiment, the metal silicate is selected from the group consisting of alkali metal silicate, alkaline earth metal silicate and a mixture thereof. In some embodiments, the metal silicate is sodium silicate. In an embodiment, the aqueous solution of metal silicate is prepared by mixing the alkali metal silicate and/or alkaline earth metal silicate with water for a time period ranging between 1-10 hours while stirring. In an embodiment, the metal silicate has a pH between 11-14. In some embodiments, the metal silicate has pH of 12.5±0.5.

In an embodiment, the mineral acid is selected from the group consisting of sulphuric acid, hydrochloric acid, and nitric acid. In an embodiment, the mineral acid has the concentration (in water) in a range of 90-100%.

In an embodiment, the reaction of the aqueous solution of metal silicate with the mineral acid is carried out by separately adding the aqueous solution of metal silicate, the mineral acid, and the surfactant solution to an aqueous medium heated up to the reaction temperature. A reactor containing the aqueous medium and connected to a heater is simultaneously charged with the aqueous solution of the metal silicate, the mineral acid, and the surfactant solution to carry out afore-said reaction. In an embodiment, the aqueous medium is formed of water only.

In an embodiment, the aqueous solution of the metal silicate, the mineral acid, and the surfactant solution are added in a ratio ranging between 10:1.5:0.5 to 15:2:1.5. In some embodiments, the aqueous solution of the metal silicate, the mineral acid, and the surfactant solution are added in the ratio of 13:1.7:1.

In an embodiment, the aqueous solution of metal silicate, the mineral acid, and the surfactant solution are added in a continuous manner. In an alternate embodiment, the addition may be stopped intermittently to allow intermittent aging of the reaction mixture.

In an embodiment, in both the steps (b) and (c) the aqueous solution of metal silicate, the mineral acid, and the surfactant solution are simultaneously added to the aqueous medium over a time period in a range of 30 minutes to 1 hour. The addition rate of the metal silicate solution, and the mineral acid, may further be adjusted to maintain the pH of 8 to 10.

In an embodiment, in both the steps (b) and (c), once the reaction mixture has attained the pH of 8 to 10, it is allowed to age at the temperature in a range of about 75 to 90° C. for a time period of 5-30 minutes.

In an embodiment, in step (c), after the completion of the reaction, the pH of the reaction is rapidly brought down to the pH of around 3.5-4. The pH of the reaction mixture is adjusted to about 3.5-4 by addition of the mineral acid.

In an embodiment, the reaction mixture is allowed to age at the pH of about 4 for a time period in a range of 5-10 minutes. In accordance with a related embodiment, the aging is carried out at a temperature in a range of 75-90° C. while continuously stirring the reaction mixture.

In an embodiment, the precipitated silica obtained upon completion of reaction is filtered followed by washing. Washing is done to eliminate the by products, such as sodium sulphate, obtained because of reaction. The precipitated silica thus obtained is then subjected to a drying step. The drying step may be carried out by spray drying, spin flash drying, or vacuum tray drying. Alternatively, the wet cake is subjected to short-term drying, followed by addition of a dispersing agent in a suitable solvent. The dispersion may then be dried to obtain precipitated silica. In an embodiment, the dispersion of silica is prepared using a dispersing agent selected from the group consisting of metal salt of saturated and unsaturated fatty esters with long hydrocarbon chain/fatty acids in an appropriate solvent selected from the group consisting of butanol, butanone, toluene and acetone.

### EXAMPLES

The following examples are provided to explain and illustrate the preferred embodiments of the present disclosure and do not in any way limit the scope of the disclosure as described:

### Example 1: Process for Preparing Exemplary Precipitated Silica

Sodium silicate solution having a solid content of approximately 30% by wt. (Na₂O to SiO₂ ratio=1:3.2, silica percentage by wt.=23%, Na₂O percentage by wt.=7.0%) was used for the silica synthesis. This solution has a pH value of 12.5±0.5.

10 litres of 50% sulphuric acid solution was prepared by slowly adding 5 litres of concentrated sulphuric acid (% of sulphuric acid in the solution=98%, Sp. Gr. of the solution=1.84) to 5 litres of distilled water.

To prepare the surfactant solution, 17.5 millilitre of C8 to C20 sulfosuccinate blend surfactant was added to 600 millilitres of distilled water and stirred.

In order to synthesize precipitated silica, 34 litres of distilled water was taken in a properly cleaned 70 litre jacketed reactor. The heater was set at 75-90° C. and the stirrer of the reactor was set at a stirring rate of 200 rpm. In the first stage, 2 litres of 50% sulphuric acid and 11.7 litres of sodium silicate solutions and 600 mililitre of the surfactant solution were taken in three separate beakers. Three metering pumps were calibrated: 1^{st} for acid, 2^{nd} for sodium silicate addition and 3^{rd} for surfactant solution. The addition rate of all the three pumps was set as follows: 1st pump for the addition of sulphuric acid at 17 millilitres/minute, 2^{nd} for the addition of sodium silicate solution at 130 millilitres/minute, 3^{rd} for the addition of surfactant solution at 10 millilitres/minute. When the temperature of the reactor reached to about 75-90° C., the required quantity of sodium silicate was added to the reactor and the pH of the solution in the reaction chamber was checked. At this point, it was ensured that the pH of the reaction mixture is between pH 8 to 10. Further on, the reaction was carried out in two stages.

In the first stage, sulphuric acid, sodium silicate and surfactant metering pumps were switched on at the addition rate of 17 millilitres/minute, 130 millilitres/minute and 10 millilitres/minute respectively. The reaction mixture was stirred at 200 rpm at a temperature between 75-90° C. After 30 minutes, the addition of surfactant solution was stopped while continuing the addition of sulphuric acid and sodium silicate for another 15 minutes. Then the addition of all the reactants was stopped while continuing the stirring at 200 rpm and 75-90° C. reactor temperature. The reaction mixture was then allowed to age for 20 minutes. The pH of the solution in the reaction chamber was checked. At this point, it was ensured that the pH of the reaction mixture is between pH 8 to 10.

In the second stage, the addition of sulphuric acid, sodium silicate and surfactant were started at the addition rate of 17 millilitres/minute, 130 millilitres/minute and 10 millilitres/minute while stirring at 75-90° C. for next 45 minutes. After 30 minutes of the above addition, the addition of surfactant solution was stopped. The pH of the solution in the reaction chamber was checked. It was ensured that the pH of the reaction mixture is between 8 to 10. After the completion of 45 minutes, the addition of sulphuric acid, sodium silicate and water were stopped. The reaction mixture was allowed to age for another 5 minutes while stirring at 75-90° C. After 5 minutes of aging, 50% sulphuric acid was added to the reaction mixture at 100 millilitres/minute. The pH was measured till the reaction mixture attained a pH of 3.5-4.0. After pH adjustment, the addition of sulphuric acid was stopped. The reaction mixture was allowed to age for 5 minutes at 75-90° C. with continuous stirring.

At the end of the reaction, the precipitated slurry was collected from the reactor. The precipitate was centrifuged and the cake was washed thoroughly with distilled water to remove sodium sulphate. The washing was continued till the conductivity of the washed liquid reaches less than 1000 μS/cm. The solid content of the wet cake thus obtained was checked and found to be 15-20%. The washed silica cake was homogenized to make silica slurry with total silica content of 10-15%. The pH of the slurry was maintained at 5.5-6.5 by addition of sulphuric acid or ammonia. The resultant slurry was then spray dried to powder. The moisture content of spray dried silica was in the range of 3-6%. Post-synthesis, a detailed characterization of synthesized precipitated silica was carried out.

Post synthesis, a detailed characterization of synthesized precipitated silica was carried out. The properties of the precipitated silica have been summarized in table 1.

TABLE 1
Properties of exemplary precipitated silica

| | | | Observed |
|---|---|---|---|
| | Reference | | Value |
| | Test | | Silica of |
| Properties | Method | Units | invention |
| Nitrogen surface area (BET) | ISO 9277 | m²/g | 180 |
| CTAB surface area | ISO 5794-1G | m²/g | 170 |
| DOA Absorption value | ASTM D6854 | mL/100 g | 272 |
| (Powder) | | | |
| Sears Number | Internal | ml/5 g | 22 |
| Sears number/BET ratio | Internal | mL/5 m² | 0.12 |
| Sears number/CTAB ratio | Internal | mL/5 m² | 0.13 |
| Silanol group density by LOI | Internal | Number | 14.24 |
| method w.r.t BET surface | | OH/nm² | |
| area | | | |
| Vicinal and Isolated silanol | Si NMR | % | 17.86 |
| group | | | |
| Geminal group | Si NMR | % | 2.44 |
| Siloxane group | Si NMR | % | 79.69 |
| Total pore volume | Hg porosimetry | ml/g | 2.5055 |
| Particle size distribution, | ISO 13320 | μm | D₅₀ = 17.9 |
| hydro method (% V) | | | |
| Total Intrusion volume | Hg porosimetry | mL/g | 2.5003 |
| Pore volume ratio V2/V1 | Hg porosimetry | — | 0.5799 |
| Total pore area | Hg porosimetry | m²/g | 52-70 |

### Example 2: Comparison of Exemplary Precipitated Silica with a Commercially Available Precipitated Silica

The precipitated silica prepared in accordance with an embodiment of the present disclosure was compared with a commercially available precipitated silica-Ultrasil 7000 GR (from “Evonik”). Table 2 shows the properties of Ultrasil 7000GR.

TABLE 2
Properties of Ultrasil 7000GR

| | Reference | | Observed |
|---|---|---|---|
| Properties | method | Unit | value |
| Nitrogen surface area (BET) | ISO 9277 | m²/g | 175 |
| CTAB surface area | ISO 5794-1G | m²/g | 160 |
| Loss on drying (105° C., | ISO 787-2 | % | 5.5 |
| 2 hrs) | | | |
| pH value (5% in water) | ISO 787-9 | — | 6.5 |
| Electrical conductivity (4% | ISO 787-14 | μS/cm | ≤1300 |
| in water) | | | |
| Pour density | ASTM D 1513 | g/l | 260 |
| SiO2 content | ISO 3262-19 | % | ≥97 |
| Sears number | Internal | ml/5 g | 18 |
| Sears number/BET ratio | Internal | mL/5 m² | 0.1028 |
| Sears number/CTAB ratio | Internal | mL/5 m² | 0.1125 |
| Silanol group density by LOI | Internal | Number | 15.1 |
| method w.r.t BET surface | | OH/nm² | |
| area | | | |
| Vicinal & Isolated group | Si NMR | % | 20.08 |
| Geminal group | Si NMR | % | 1.92 |
| Siloxane group | Si NMR | % | 78.00 |
| Particle size distribution, | ISO 13320 | μm | 17.7 |
| hydro method (% V) | | | |
| Total pore volume | Hg porosimetry | mL/g | 1.5824 |
| Total pore area | Hg porosimetry | m²/g | 170.76 |

Two curable elastomer compositions were prepared-COMP and INV1. COMP comprises of curable elastomer composition including Ultrasil 7000GR, and INV1 comprises of curable elastomer composition including precipitated silica prepared in Example 1. Table 3 provides the composition of the two elastomer compositions.

TABLE 3
Composition of INV1 and COMP

| Ingredients* | INV1 | COMP |
|---|---|---|
| Synthetic Rubber Styrene Butadiene Rubber (SSBR) | 70 | 70 |
| solution (from Zeon Corp) | | |
| Polybutadiene Rubber (PBD) (from Kumoh) | 30 | 30 |
| Inventive precipitated silica | 70 | 0 |
| Ultrasil 7000GR | 0 | 70 |
| Carbon Black (N234) | 5 | 5 |
| Process Oil (from IPOL) | 14 | 14 |
| Silane Coupling Agent - Si 69 (from Pukhraj) | 5.8 | 5.8 |
| Stearic Acid | 2 | 2 |
| MC Wax (from Raj Petro) | 1.5 | 1.5 |
| Zinc Oxide (ZnO) (from RUBAMIN) | 3 | 3 |
| 6PPD (from Pukhraj) | 2 | 2 |
| TDQ (from Pukhraj) | 1 | 1 |
| Sulphur | 1.5 | 1.5 |
| CBS (from Pukhraj) | 1.7 | 1.7 |
| TBzTD (from Yasho Industries) | 0.3 | 0.3 |
| DPG (from Zeon Corp) | 1.5 | 1.5 |

*All quantities in PHR (Parts Per Hundred Rubber)

The above components were mixed in a 1.6 liter (Bainite make, Model MB Series 1.6 L IM RES-O-LAB) mixer with fill factor of 74%. The mixing was initiated at the temperature of 50-55° C. and the dumping temperature was 155±2° C., while maintaining RAM pressure at 20 kg. For the first 6 minutes, polymer along with silica, coupling agent, carbon black, processing oil, stearic acid, and wax was masticated at speed 40-60 RPM. In the second stage, 6PPD, TDQ and ZnO were added and further masticated for 3 to 4 minutes till dumping temperature of 155±2° C. was achieved. During this process, speed was varied between 50-70 RPM to achieve the dumping temperature. The mixing sequence has been summarized in table 4 below.

TABLE 4
Mixing Sequence for rubber compounding

| Mixing | | | | |
|---|---|---|---|---|
| Stage | Time | | Temperature | Components mixed |
| I | 0 | minute | 50-55° C. | Polymer + silica + coupling |
| | | | | agent + carbon black + stearic |
| | | | | acid + wax |
| II | 7 | minutes | 80-105° C. | 6PPD + TDQ + ZnO |
| III | 10 | minutes | | Master batch dumping between 9th |
| | | | | to 10th minute at 155 ± 2° C. |

The final moulded and compounded batch was prepared in an open two-roll mill, Lab mill (12×16″) at room temperature, with friction ratio of 1:1.25. While adding accelerator and curatives, nip gap was kept at approximately 1 mm and was masticated for 4 to 6 minutes. For all compounds, final sheet was taken out from approximately 3.8 mm nip gap. All compounds were conditioned for 24 hours at room temperature and then submitted for characterization.

The properties of the compounded rubber were studied and have been summarized in table 5 below.

TABLE 5
Properties of unvulcanized rubber compounds

| Properties | UOM | INV1 | COMP |
|---|---|---|---|
| Scorch Time ts₂ @ 160° C. | Minutes | 3.00 | 2.51 |
| Mooney Viscosity | Mooney Units (MU) | 68 | 90 |
| Mooney Scorch Time, T₅ @ | Minutes | 21 | 16 |
| 125° C. | | | |
| ΔG′, Payne Effect | KPa | 450 | 679 |

Observation: It was observed that INV1 showed improved rubber compounding processability (as evidenced by lower mooney viscosity) and lower filler-filler interaction (indicated by lower Payne effect) in the rubber matrix. Also, INV1 exhibits better scorch safety at 160° C. and 125° C. as compared to COMP.

For testing the properties of vulcanized rubber compounds, rubber slab and other samples were cured at 160° C. as per curing time given in the below table 6:

TABLE 6
Curing time for INV1 and COMP

| Sample | INV1 | COMP |
|---|---|---|
| Curing Time (minutes) | 9 | 8 |

All the molded samples were observed to be free from visible defects. Molded samples were preconditioned at room temperature before further testing the mechanical properties thereof. The results of the tests have been summarized in table 7, 8, 9 and 10 below:

TABLE 7
Modulus at various strains before and after
aging (80° C. for 7 days in air oven)

| | Before/After | | Cured | Cured |
|---|---|---|---|---|
| Properties | Aging | UOM | INV1 | COMP |
| M @ 50% | Before | Kg/cm² | 19 | 20 |
| M @ 100% | | | 37 | 44 |
| M @ 200% | | | 100 | 112 |
| M @ 50% | After | | 24 | 30 |
| M @ 100% | | | 50 | 66 |
| M @ 200% | | | 133 | — |

TABLE 8
Tensile Strength, Elongation, Tear Strength and Hardness at various
strains before and after aging (80° C. for 7 days in air oven)

| | Before/After | | | |
|---|---|---|---|---|
| Properties | Aging | UOM | INV1 | COMP |
| Tensile Strength | Before | Kg/cm² | 159 | 139 |
| Elongation | | % | 265 | 223 |
| Tear Strength | | Kg/cm | 49 | 50 |
| Hardness | | Shore A | 70 | 70 |
| Tensile Strength | After | Kg/cm² | 147 | 126 |
| Elongation | | % | 226 | 167 |
| Tear Strength | | Kg/cm | 44 | 42 |
| Hardness | | Shore A | 72 | 73 |

Observation: Cured INV1 exhibits significantly improved physical properties such as tensile strength and elongation both before as well as after aging as compared to cured COMP.

TABLE 9
Abrasion Resistance Index, Cut Initiation
and Cut Growth and specific gravity

| | | Cured | Cured |
|---|---|---|---|
| Properties | UOM | INV1 | COMP |
| Abrasion Resistance Index | — | 173 | 174 |
| De-Mattia Cut Initiation | Kilocycles | 26 | 5 |
| De-Mattia Cut Growth (Upto 12 mm) | Kilocycles | 20 | 8 |
| Specific Gravity | — | 1.20 | 1.20 |

Observation: Cured INV1 exhibits significantly improved cut initiation as well as growth properties as compared to cured COMP.

TABLE 10
Dynamic Mechanical Analysis

| Properties | Cured INV1 | Cured COMP |
|---|---|---|
| Tan δ @ 0° C. | 0.197 | 0.184 |
| Tan δ @ 60° C. | 0.080 | 0.063 |

Observation: Cured INV1 exhibits improved wet grip/traction as compared to cured COMP.

### INDUSTRIAL APPLICABILITY

The precipitated silica according to the present disclosure finds application as reinforcing filler in vulcanizable or vulcanized elastomer compositions. The vulcanized elastomer composition can be used for the manufacture of tyre and other rubber products. Any conventional process may be used to form vulcanizable or vulcanized elastomer compositions using the disclosed silica as reinforcing filler.

The precipitated silica according to the present disclosure has specific physico-chemical attributes. The disclosed precipitated silica when used as filler in elastomer compositions exhibits superior rheological, mechanical and dynamic properties as compared to elastomer compositions reinforced with prior known silica. Also, it exhibits improved dispersibility in the elastomer composition as compared to known precipitated silica.

The disclosed precipitated silica requires lesser number of mixing stages in the elastomer compositions.

We claim:

1. A precipitated silica having:
a BET surface area of 165-195 m²/g;
a CTAB surface area of 160-180 m²/g;
a vicinal silanol content of 14 to 21%;
a geminal silanol content of 2 to 4%;
a total intrusion volume of 2 to 4 mL/g;
a pore volume ratio (V2/V1) of 0.45 to 0.7; and
a total pore area ranging from 52 to 70 m²/g.

2. The precipitated silica as claimed in claim 1, having a DOA absorption value in the range of 240-310 ml/100 g.

3. The precipitated silica as claimed in claim 1, having a sears number (V₂) of 19 to 25 ml (5 g).

4. The precipitated silica as claimed in claim 1, having a ratio of sears number and BET surface area of 0.11 to 0.13 mL/5 m².

5. The precipitated silica as claimed in claim 1, having a ratio of sears number and CTAB surface area of 0.11 to 0.15 mL/5 m².

6. The precipitated silica as claimed in claim 1, having a ratio of silanol group density and BET surface area of 12.24 to 16.24 Number OH/nm².

7. The precipitated silica as claimed in claim 1, having a siloxane group content of 74 to 85%.

8. The precipitated silica as claimed in claim 1, having a total pore volume of 1.50 to 3.6 ml/g.

9. The precipitated silica as claimed in claim 1, has a particle size distribution D₅₀ ranging from 14 to 21 μm.
